(19) United States
(12) Patent Application Publication
(10) Pub. No.: US 2004/0095587 A1
(43) Pub. Date: May 20, 2004

(54) Apparatus and method for reducing resources used by an image communication and printing device

(76) Inventors: Mark L. Brown, Boise, ID (US); Vincent C. Skurdal, Boise, ID (US); Marvin D. Nelson, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/294,278

(22) Filed: Nov. 14, 2002

(51) Int. Cl. G06F 15/00

(52) U.S. Cl. 358/1.2; 358/1.18

(57) ABSTRACT

The present invention provides a system and method for conserving resources when images are printed. Briefly described, in architecture, one embodiment comprises receiving a communication comprising at least a plurality of images, the images lacking information specifying image attributes, analyzing each image for at least one characteristic corresponding to the image attribute, determining a maximum amount of reduction in size for each one of the images based upon the analyzed characteristic, determining a page layout for selected ones of the plurality of images at the determined reduced-size such that at least two reduced-size images are laid out together onto a single sheet of paper, and communicating the determined page layout to a printing unit so that the sheet of paper is printed having the selected reduced-sized images.

### TECHNICAL FIELD

The present invention is generally related to communicating and printing images and, more particularly, is related to a system and method for reducing the resources used in a device that receives and/or prints communicated images.

### BACKGROUND

Image communication devices are configured to receive electronic information corresponding to images such that the images are printed on a printing medium. A nonlimiting example of a printing device includes a facsimile (FAX) machine. Such devices or systems receive images from a sending device over a communication medium. For example, a FAX machine may receive a communication made of a plurality of images over a telephone line, or a PC may receive an e-mail comprised of a plurality of images over a the Internet. Images may be images of objects and/or textual information.

In some situations, such communications do not include information describing aspects of the communication. For example, the presence of text or of images are not indicated. Also, for text, font size and/or font type information may not be indicated. This type of communication is quite different from a communicated word processing document that includes the above-described information indicating attributes of the document. Printing devices such as a FAX machine, are configured to print received communication even in the absence of the above-described attribute information.

Often, the resources of the device printing the received communication, generally comprised of a plurality of images, are wasted. For example, some images may each require a single sheet of paper for printing. Also, large amounts of ink may be used for images of large objects. Other received images may have large blank regions where no image or text appear on the printed medium. Accordingly, a received plurality of images, each image printed on a single sheet of paper, may waste the resources of the printing device (paper and/or ink).

In other instances, some identifiable senders may be known to send communications having undesirable images or unimportant images that impart little or no relevant information on a printed page to the receiver. Such senders of “junk mail” waste resources when pages of undesirable images are printed.

Furthermore, received images may include color. When printed in color, expensive color ink is used to print the junk mail images. If the image is undesirable, or if color is not necessary, color ink is wasted.

### SUMMARY

The present invention provides a system and method for conserving resources when images are printed. Briefly described, in architecture, one embodiment comprises receiving a communication comprising at least a plurality of images, the images including information specifying image attributes, analyzing each image for at least one characteristic corresponding to the image attribute, determining a maximum amount of reduction in size for each one of the images based upon the analyzed characteristic, determining a page layout for selected ones of the plurality of images at the determined reduced-size such that at least two reduced-size images are laid out together onto a single sheet of paper, and communicating the determined page layout to a printing unit so that the sheet of paper is printed having the selected reduced-sized images.

### BRIEF DESCRIPTION OF THE DRAWINGS

The components in the drawings are not necessarily to scale relative to each other. Like reference numerals designate corresponding parts throughout the several views.

FIG. 1 is a block diagram illustrating a plurality of images received by an embodiment of the present invention.

FIG. 2 is a block diagram illustrating four received images combined onto a single page of paper by an embodiment of the present invention.

FIG. 3 is another block diagram illustrating three received images combined onto a single page of paper by an embodiment of the present invention.

FIG. 4 is another block diagram illustrating two received images combined onto a single page of paper by an embodiment of the present invention.

FIG. 5 is block diagram illustrating three received images combined onto a single sheet of paper by another embodiment of the present invention.

FIG. 6 is block diagram illustrating three received images combined onto a single sheet of paper by another embodiment of the present invention.

FIG. 7 is another block diagram illustrating portions of received images combined onto a single sheet of paper by an embodiment of the present invention.

FIG. 8 is a block diagram illustrating one embodiment of an image communication system configured to receive and print a plurality of images in accordance with the present invention.

FIG. 9 is a flowchart of a process for conserving resources by an embodiment of the present invention.

FIG. 10 is a flowchart illustrating additional detail of the blocks for determining the maximum amount of image reduction and page layout in FIG. 9.

FIGS. 11A-C are flowcharts illustrating additional detail of the block for analyzing image characteristics in FIG. 9.

### DETAILED DESCRIPTION

The present invention provides a system and method for conserving resources in a printing device when a plurality of received images are printed on a print medium. More specifically, resources conserved by the present invention include the amount of printing medium used for printing the plurality of received images, and/or the amount (and/or type of) ink used to print the received images.

A printing medium is referred to herein as “paper” for convenience. Printing mediums are intended to include any of the numerous types, sizes and varieties of paper that images are printed on. Furthermore, for convenience, the term “ink” is referred to herein as the material that is applied to the printing medium. For example, a laser type printing device uses a dry toner applied to the paper, which is then fused to the paper using heat. An ink jet type printing device uses a liquid ink sprayed onto the paper. “Ink” may be black and/or colored. It is intended that any device that applies ink to a printing media in accordance with the present invention is disclosed herein and is protected by the accompanying claims.

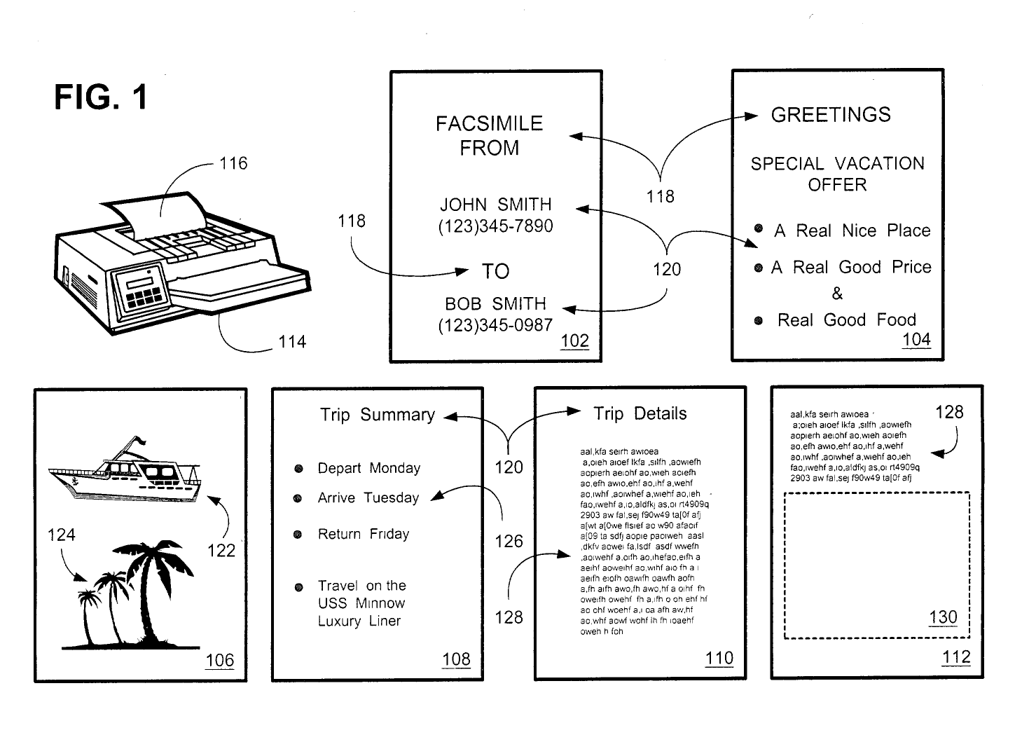

FIG. 1 is a block diagram illustrating a plurality of images 102, 104, 106, 108, 110 and 112 received by an embodiment of the present invention. The device 114 receives and prints information corresponding to the plurality of images that are to be printed on the paper 116.

For convenience of describing the present invention, the simplified example of FIG. 1 indicates that a communications having six images 102, 104, 106, 108, 110 and 112 has been received by a facsimile (FAX) machine 114. For convenience, the term image as used herein for one embodiment corresponds to a “page” of a FAX communication. The received communication does not include information describing attributes of the images. Text and/or images of objects are not identified as such. For textual information, font size and/or font type specifications are not provided. A non-limiting example of a communication lacking image attribute information is a FAX message.

Other communications may be comprised of other numbers of images. All received communications having any number of images may be processed by the present invention in a manner that conserves the resources (paper and/or ink) of the printing device.

For convenience, the device 114 is illustrated as a FAX machine that is configured to couple to a telephone system (not shown), receive a communication comprising a plurality of images lacking image attribute information, and then print the plurality of received images in accordance with the present invention. Another embodiment is configured as a multi-function device that receives communications comprised of a plurality of images. A non-limiting example of this embodiment is a personal computer (PC). The received plurality of images are processed in accordance with the present invention, and then the processed images are communicated to a separate printing device for printing. Other embodiments are implemented in other types of multi-function devices that have components for receiving images and printing images. For example, but not limited to, such multi-function devices include components for copying images, capturing images and/or scanning objects.

It is understood that a conventional FAX machine (not shown) would print the six images 102, 104, 106, 108, 110 and 112 on six separate sheets of paper. When compared to the plurality of images processed and printed in accordance with the present invention that prints all six images while conserving paper and/or ink, as described in greater detail herein, it is apparent that the conventional FAX machine that prints the six images 102, 104, 106, 108, 110 and 112 on six separate sheets of paper is less efficient than device 114 employing the present invention.

To appreciate the present invention, attributes of the six images 102, 104, 106, 108, 110 and 112 are described. Image 102 is an image of text. A first large font size 118 is used for the exemplary text “FASCIMILE FROM” and “TO” on the image 102. A second font size 120 in used for the name and telephone numbers of the sender (John Smith) and recipient (Bob Smith) of the exemplary communication. Although the font size 120 is smaller than the font size 118, the font size 120 is depicted as being larger than the typically encountered 12 point or 10 point font size used for printing easily discernable text.

Image 104 is another image of text. Image 104 includes text having a font sizes 118 and 120, in addition to other symbols (dots or “bullets” denoting items of interest).

Image 106 includes images of a boat 122 and a small tropical island 124. Here, image 106 includes no textual information.

Image 108 is another image of text including text having the second font size 120 and a third font size 126. Although font size 126 is smaller than the font size 120, the font size 126 is depicted as being larger than the typically encountered 12 point or 10 point font size used for printing easily discernable text.

Image 110 is another image of text including text having the second font size 120 and a fourth font size 128. Font size 128 is smaller than the font size 120 or 126, and for illustrative purposes, the font size 128 is depicted as the typically encountered 12 point or 10 point font size used for printing easily discernable text. (It is understood that if the text of the font size 128 was discernible in the illustrative image 110, the text would impart information relevant to the subject matter of the facsimile communication and the associated images.)

Image 112 is yet another image of text including text having the fourth font size 128. Also included on image 112 is a blank region 130. Here, it is understood that in the illustrative example of the six images 102, 104, 106, 108, 110 and 112, the information communicated in the six images 102, 104, 106, 108, 110 and 112 is concluded on image 112. Thus, the text ends on the image 112, thereby resulting in the blank region 130.

The above described attributes of the six images 102, 104, 106, 108, 110 and 112 were described to illustrate that images communicated to FAX machine 114 employ images of objects and/or textual information. The received communication comprising the six images 102, 104, 106, 108, 110 and 112 does not include information on the above-described image attributes. Communications having a plurality of images can comprise any combination of object images and/or textual information, and employ any number of images.

Embodiments constructed in accordance with the present invention analyze the above described attributes of communicated images, and other attributes described herein, to determine if the printed images can be processed in a manner that conserves resources of the printing unit (or a remote printing device, if a separate component) according to a plurality of print page layout preferences, described herein. Generally, the present invention analyzes the attributes of an image and the applicable layout preferences to determine which images can be reduced in size and printed together on a single sheet of paper. For example, if the determined attributes of two images satisfy certain criteria, the two images are reduced and printed together on a single sheet of paper. Accordingly, resources are conserved in that one sheet of paper, rather that two separate sheet of paper, are required for image printing. If duplex printing capability is supported by device 114, duplex printing is selected in one embodiment to save additional sheets of paper.

Furthermore, combining multiple images and/or printing smaller images, conserves the amount of ink required to print the images. One embodiment is configured to determine if the image may be printed at a lighter shade. If so, the image is printed using less ink (toner saving mode). In another embodiment, the presence of color in the received image is determined. Under certain criteria, the color portions are printed in a suitable gray scale or in black.

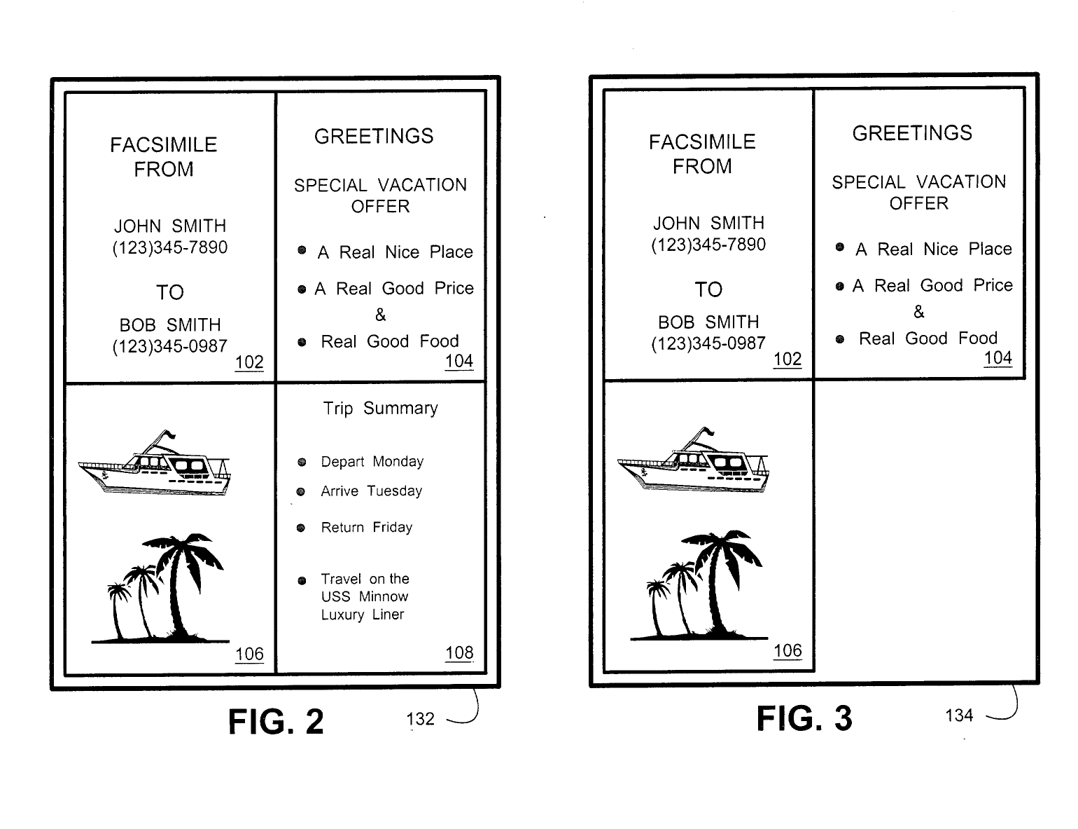

FIG. 2 is a block diagram illustrating four received images 102, 104, 106 and 108 (see also FIG. 1) combined onto a single sheet of paper 132 by an embodiment of the present invention. As described in greater detail herein, embodiments of the present invention analyze attributes of the received images 102, 104, 106 and 108. As described above, images 102, 104 and 108 include textual information corresponding to font sizes 118, 120 and 126. In this illustrative example, the font sizes 118, 120 and 126 greater than a predefined font size criteria. Accordingly, the images 102, 104 and 108 are categorized as being suitable for printing as a reduced-size image. That is, in this illustrative example, it is understood that if the area of the images 102, 104 and 108 are reduced to quarter size, that the textual information will remain discernible at the reduced-size when printed together on a single sheet of paper.

Furthermore, image 106 has the attribute that images of objects are included on image 106. In one embodiment, one layout preference specifies that received images having only images of objects are categorized as being suitable for reduced-size printing.

Another embodiment determines attributes associated with an image of an object. If the attributes of the image of the object exceed a predefined threshold, the layout preferences categorize the image as being suitable for reduced-size printing. For example, dimensions of the image of the object such as length, width, height and/or cross sectional area may be determined and evaluated as an attribute.

Thus, attributes associated with images 102, 104, 106 and 108 are analyzed. Layout preferences are applied such that the images 102, 104, 106 and 108 are categorized as being suitable for reduced-size printing. In the illustrative example of FIG. 2, the maximum amount of reduction for each image is determined to be to a quarter of the original area, based upon a criteria that the reduced-sized images, when printed, remain discernible to a viewer. Since the area of the four successive images 102, 104, 106 and 108 can be reduced to quarter size, the present invention combines and prints the four reduced-sized images onto a single piece of paper. Accordingly, only one sheet of paper 132 is required to print the four images 102, 104, 106 and 108, thus saving three sheets of paper. When the images 102, 104, 106 and 108 are printed at a quarter size on paper 132, text associated with the images 102, 104 and 108 is discernable to the viewer of the paper 132. Similarly, the nature of the objects on image 106 are discernible to the viewer of the paper 132.

FIG. 3 is another block diagram illustrating three received images 102, 104 and 106 combined onto a single sheet of paper 134 by an embodiment of the present invention. In this illustrative example, the font size 126 on image 108 is determined to be equal to or less than the predefined minimum font size criteria permissible for the reduction of an image to the quarter size area. Accordingly, the embodiment determines that image 108 is not suitable for printing at a reduced size. However, the font sizes 118 and 120 exceed the predefined minimum font size criteria. Also, the attributes of the object images on image 106 are determined such that the area of the image 106 may be reduced to a quarter size. In the illustrative example of FIG. 3, the maximum amount of area reduction for each image is determined to be to a quarter of the original size, based upon the predefined font size criteria. The criteria provides that the text of the reduced-sized images, when printed, remain discernible to a viewer. Since the area of the three successive images 102, 104, and 106 can be reduced to quarter size, the present invention combines and prints the three reduced-sized images, as determined by the applicable layout preferences, onto a single sheet of paper. Accordingly, only one sheet of paper 134 is required to print the three images 102, 104 and 106, thus saving two sheets of paper.

It is noted that the images 102, 104, 106 and 108 are configured in a portrait format. In one embodiment, reduced-sized images are maintained in the orientation of the originally received image. In an alternative embodiment, image orientation is changed to conserve the greatest amount of resources. Thus, if an image is received in a landscape orientation and can be reduced as determined by the present invention, the layout preferences provide that the orientation of the reduced-sized image may be changed such that the reduced-sized image is rotated 90 degrees to fit with other reduced-sized images on the printed page.

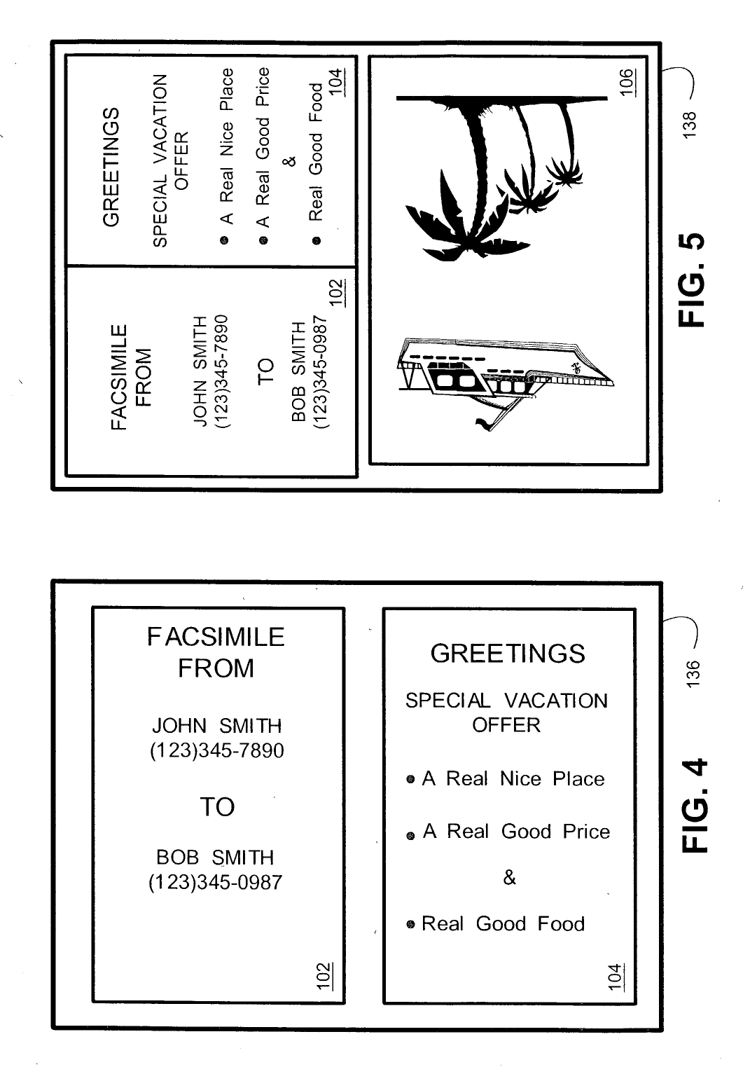

FIG. 4 is another block diagram illustrating two received images 102 and 104 combined onto a single sheet of paper 136 by an embodiment of the present invention. In this illustrative example, the font size 120 on images 102 and 104 is determined to be equal to or less than the predefined font size criteria that allows for the reduction of the area of an image to the quarter size scale. However, the font size 120 exceeds the predefined font size criteria that allows for the reduction of the area of an image to a half size. In the illustrative example of FIG. 4, the maximum amount of reduction for each image is determined to be to one half of the original area of images 102 and 104, based upon a criteria that the text of the reduced-sized images, when printed, remain discernible to a viewer. Since the area of two successive images 102 and 104 can be reduced to half size, the present invention combines and prints the two reduced-sized images onto a single sheet of paper 134. Accordingly, only one sheet of paper 134 is required to print the two images 102 and 104, thus saving one sheet of paper. Accordingly, a different predefined font size criteria was employed in the illustrative examples of FIGS. 1 and 2, when compared to the illustrative example of FIG. 3.

Comparing the illustrative examples of FIGS. 2 and 3, where a predefined font size criteria resulted in a determination that the area of the successive images 102 and 104 could be reduced to a quarter size, and the example of FIG. 4, where a predefined font size criteria resulted in a determination that the area of the successive images 102 and 104 could be reduced to a half size, one embodiment employs a layout preference that selects the smallest size reduced image (greatest amount of reduction) that meets the criteria. With this layout preference, an individual image, even if by itself on the printed sheet of paper, will be reduced. Thus, each received image is reduced to the maximum amount possible, and then successive images are oriented onto the printed sheet to minimize the use of resources.

Other embodiments employ different print page layout preferences (image reduction and/or orientation algorithms). One embodiment first determines the maximum amount of reduction possible for each received image. Then, the embodiment takes the images in order, and determines the placement and orientation of individual reduced-sized images on the printed page of paper, based upon applicable criteria. FIG. 5 is block diagram illustrating three received images 102, 104 and 106 combined onto a single sheet of paper 138 by an embodiment of the present invention. In this illustrative example, the font size 120 on images 102 and 104 is determined to be equal to or greater than the predefined font size criteria that allows for the reduction of an image to the quarter size scale. Accordingly, the maximum area reduction for images 102 and 104 is determined to be to a quarter size. However, in this example, a layout preference specifies that images of objects are not to be reduced in size by more that a half of the original image area. Accordingly, the image 106 is limited to a half sized area reduction. Since the area of the images 102 and 104 can be reduced to a quarter size, and the image 106 can be reduced to a half size, this embodiment determines that the three images can be printed on a single sheet of paper 138 if the orientation of the image 106 is rotated by ninety degrees. (It is understood that the half size of image 106 could be rotated by ninety degrees in a clockwise or counter clockwise direction, depending upon the particular print page layout preference.) Since three successive images 102, 104, and 106 can be reduced as described above, the present invention combines and prints the three reduced-sized images onto a single sheet of paper 138. Accordingly, only one sheet of paper 138 is required to print the three images 102, 104 and 106, thus saving two sheets of paper.

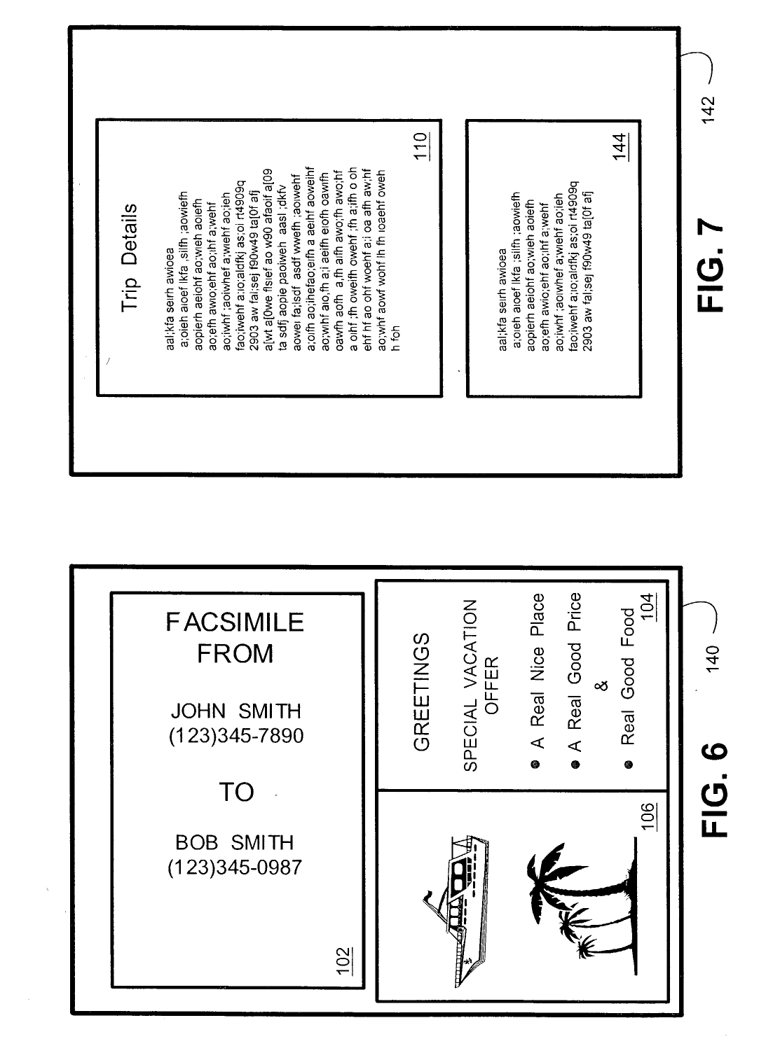

Another embodiment may limit the maximum reduction of a specified image. For example, the first received image 102, in one embodiment, is limited to a maximum area reduction to half size, even if the minimum font size criteria would otherwise permit a greater reduction. FIG. 6 is block diagram illustrating three received images 102, 104 and 106 combined onto a single sheet of paper 140 by such an embodiment. Here, even though the predefined font size criteria would allow the area of image 102 to be reduced to a quarter size, image 102 is limited to a half size reduction. However, succeeding images are scaled according to the predefined font size criteria. Thus, the embodiment determines that the images 104 and 106 can be reduced to a quarter size (assuming the above described font size criteria applied in the exemplary FIGS. 2 and 3). The half size of image 106 could be rotated by ninety degrees in a clockwise or counter clockwise direction, depending upon the particular print page layout preference. Since three successive images 102, 104, and 106 can be reduced as described above, the present invention combines and prints the three reduced-sized images onto a single sheet of paper 140. Accordingly, only one sheet of paper 140 is required to print the three images 102, 104 and 106, thus saving two sheets of paper.

It is understood that any predefined font size criteria can be specified in any suitable manner. The font size criteria specification can be made as a dimension (inches, millimeters, etc.) or another known specification, such as a font size. One embodiment identifies the smallest font on the received image, determines a scale factor corresponding to the identified smallest font and the specified font size criteria, and then reduces the received image by the determined scale factor.

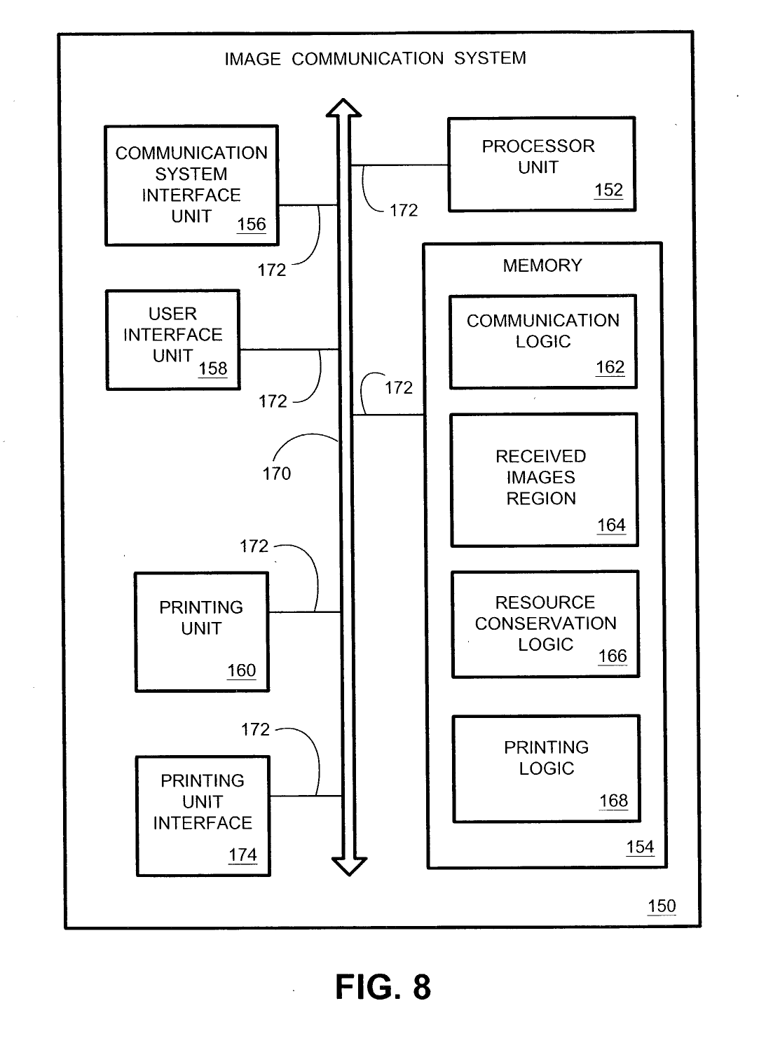

FIG. 7 is another block diagram illustrating portions of the received images 110 and 112 combined onto a single sheet of paper 142 by an embodiment of the present invention. In the illustrative example of FIG. 7, the font size 128 (FIG. 1) is identified as the smallest font size on the images 110 and 112. A scale factor is then determined based upon the ratio of the smallest identified font size of the received image and the specified font size criteria. For illustrative purposes, the image 110 in FIG. 7 is seen to be approximately 75% of its original size. Thus, in this illustrative example, the font size 128 is identified as 14 points, and the specified font size criteria is 10 points. Accordingly, the area of image 10 is scaled by approximately 75% on the printed page 142.

Additionally, a portion 144 of the image 112 has been scaled and printed on the sheet of paper 142. As described above, the received image 112 contained a blank region 130. The blank region 130, in one embodiment, is identified and then deleted. Thus, after scaling, the remaining portion 144 having the scaled text of the image 112 is printed on the sheet of paper 142. Accordingly, resources are conserved by identifying and eliminating blank regions of a received image.

Various criteria can be used to identify blank regions of a received image. For example, one criteria is that the blank region span the width of the received image. Another criteria is that the blank region of a received image have a specified minimum area. Yet another criteria is that the blank region of a received image have a minimum specified length in a specified direction. One or more of the above-described criteria may be used to identify blank regions of a received image that are suitable for elimination.

Another embodiment is configured to adjust the scale factor applied to the image to a closest predetermined scale factor. For example, predetermined scale factors may be specified as multiples of the number of complete images that fit onto a single sheet of paper. Thus, an area scale factor of 50% corresponds to two images per sheet of paper. An area scale factor of 33% corresponds to three images per sheet of paper. An area scale factor of 25% corresponds to four images per sheet of paper.

FIG. 8 is a block diagram illustrating an embodiment of an image communication system 150 configured to receive and print a plurality of images in accordance with the present invention. In one embodiment, image communication system 150 includes a processor unit 152, a memory 154, a communication system interface unit 158 and a printing unit 160. Memory 154 further includes communication logic 162, received images region 164, resource conservation logic 166 and printing logic 168. Resource conservation logic includes the various criteria used to determine the amount of reduction applied to received images, and/or to determine blank regions on a received image that are suitable for elimination, and the logical preferences that apply the various criteria to determine the scale factor.

Processor unit 152, memory 154, communication system interface unit 158 and printing unit 160 are coupled to communication bus 170 via connections 102. Communication bus 170 is coupled to processor unit 152 via connection 172, thereby providing connectivity to the above-described components. In an alternative embodiment of image communication system 150, the above-described components are connectivley coupled to processor unit 152 in a different manner than illustrated in FIG. 8. For example, one or more of the above-described components may be directly coupled to processor unit 152 or may be coupled to processor unit 152 via intermediary components (not shown).

Communication system interface unit 156 is configured to couple to a communication network (not shown) over which the communicated images are received. In one embodiment, such as, but not limited to, a FAX machine, communication system interface 156 is configured to interface to a telephone system (not shown). In another embodiment, such as, but not limited to, a PC, communication system interface 156 is configured to interface with the Internet. Other embodiments are configured to interface with other communication media, such as wireless, satellite or optical media.

Accordingly, a communication comprising at lest one image is received by the image communication system 150, through the communication system interface 156, and is saved into the received images region 164 of memory 154. In one embodiment, at the conclusion of the communication, processor unit 152 retrieves and executes the resource conservation logic 166, described in greater detail below, such that images are processed in accordance with the present invention, thereby conserving resources of printing unit 160 (or a remote printing device, if a separate component).

After processing received images into reduced-sized images and generating data having at least one reduced-sized image for printing on a sheet of paper, data for printing the at least one reduced-sized image on a sheet of paper is communicated to the printing unit 160, or communicated to a remote printing unit via printing unit interface 174, depending upon the embodiment processing the received images.

User interface 158 may be configured in one embodiment to receive instructions for operation of the resource conservation logic 166 from an operator of the image communication system 150. For example, the user may select optional criteria and/or specify criteria used to determine the amount of reduction applied to a received images and/or to identify blank regions on a received image that are suitable for elimination. Such instructions are provided by a conventional input device (not shown) or from a specially fabricated input device (not shown). For example, but not limited to, user interface 158 may be configured to receive information from the operator of the image communication system 150 via a keyboard device (not shown). Other examples of input devices include a touch pad, touch screen, mouse, rocker switches or other types of buttons. Such a feature is particularly advantageous when the input devices (not shown) are produced by different vendors that employ different data formats.

In an alternative embodiment, image communication system 150 does not include printing unit 160. Rather, a printing unit interface 174 configured to couple to a remote printing device is included. Thus, received images processed to conserve resources according to the present invention are communicated to the remote printing device for printing. Yet another embodiment includes both the printing unit 160 and the printing unit interface 174.

Processor unit 152 may be implemented as a suitable commercially available processor. Examples of commercially available processors include, but are not limited to, an 80×86 or Pentium series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation. Processor unit 152 controls the execution of a program, employed by the present invention, residing in resource conservation logic 166. Alternatively, processor unit 152 may be implemented with a specially designed and/or fabricated processing unit configured to operate the image communication system 150.

Furthermore, for convenience of illustration in FIG. 8, memory 154 is shown residing in the image communication system 150. Memory 154 may reside in alternative convenient locations outside of the image communication system 150, as components of other systems, or as stand alone dedicated elements, without adversely affecting the operation and functionality of the present invention.

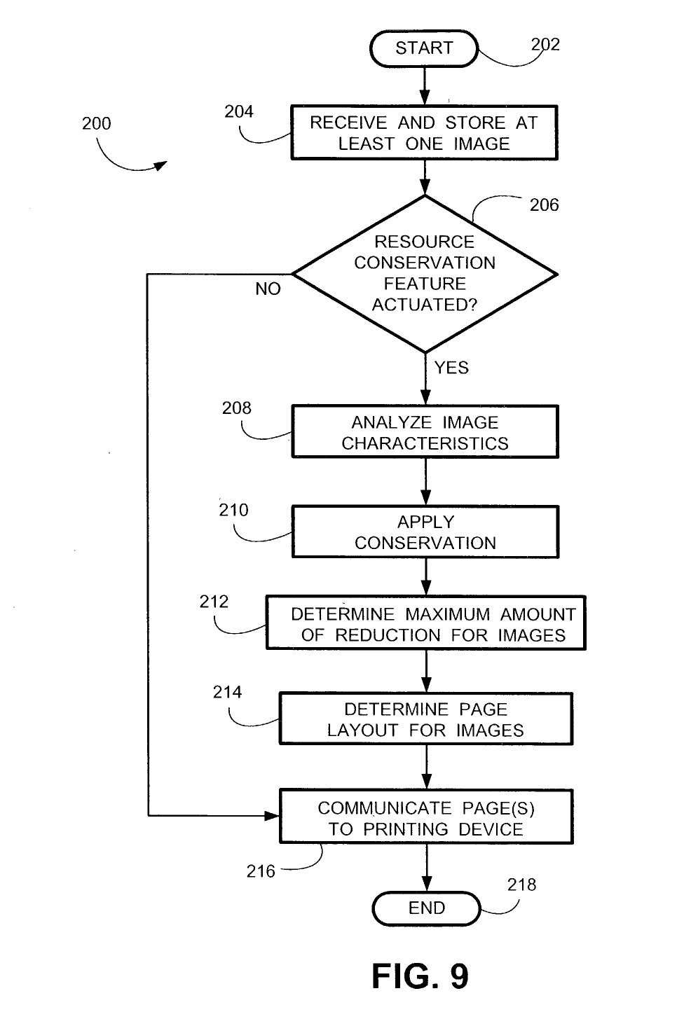

FIG. 9 is a flowchart 200 of a process for conserving resources by an embodiment of the present invention. The flow chart 200 shows the architecture, functionality, and operation of a possible implementation of the software for implementing the resource conservation logic 166 (FIG. 8). In this regard, each block may represent a module, segment, or portion of code, which comprises one or more executable instructions for implementing the specified logical function(s). It should also be noted that in some alternative implementations, the functions noted in the blocks may occur out of the order noted in FIG. 9 or may include additional functions without departing significantly from the functionality of the present invention. For example, two blocks shown in succession in FIG. 9 may in fact be executed substantially concurrently, the blocks may sometimes be executed in the reverse order, or some of the blocks may not be executed in all instances, depending upon the functionality involved, as will be further clarified hereinbelow. All such modifications and variations are intended to be included herein within the scope of this disclosure for the present invention.

The process starts at block 202. At block 204, at least one image is received and stored. At block 206, an optional block in some embodiments, a determination is made whether the resource conservation feature of the present invention is actuated. In one embodiment, the resource conservation feature is a selectable option. If selected by the user, received images may be reduced for printing as described herein. However, if the resource conservation feature is not activated or selected (the NO condition) at block 206, the process proceeds to block 216 where the received images are communicated to a printing device.

If at block 206, the resource conservation feature is activated (the YES condition), the process proceeds to block 208. In another embodiment, the resource conservation feature is always activated. That is, the feature is not selectable by the user. Accordingly, this embodiment does not include block 206.

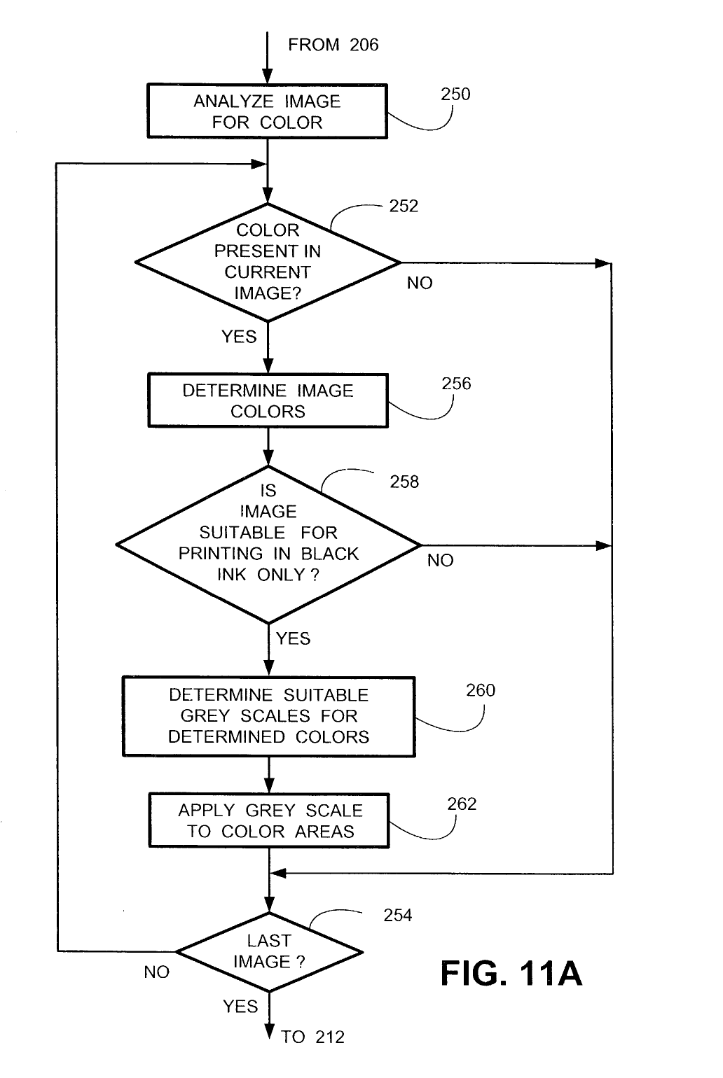

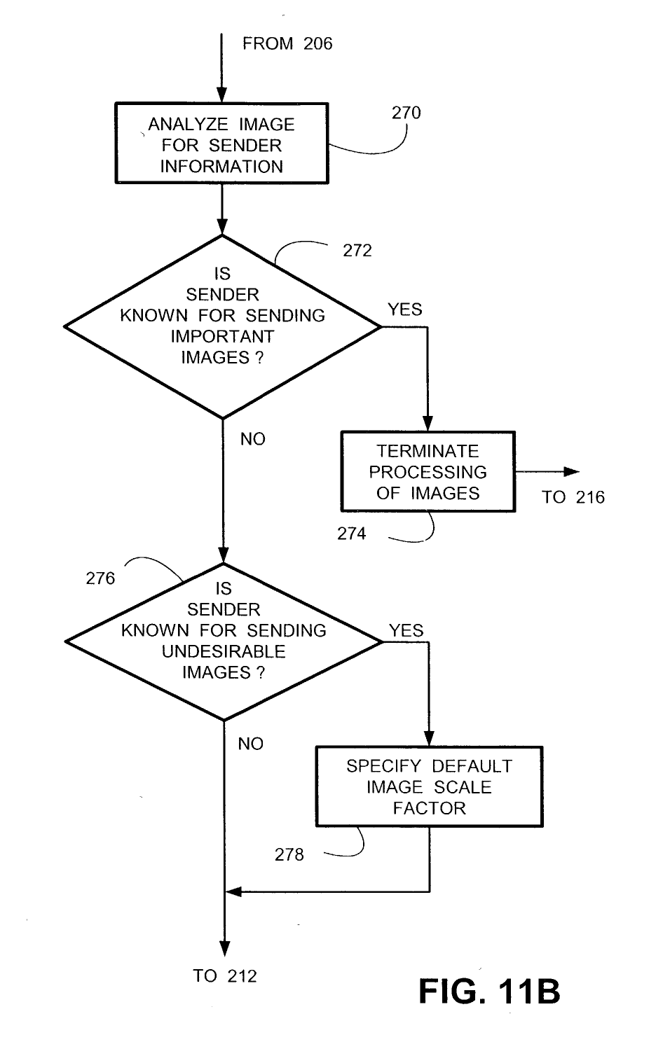

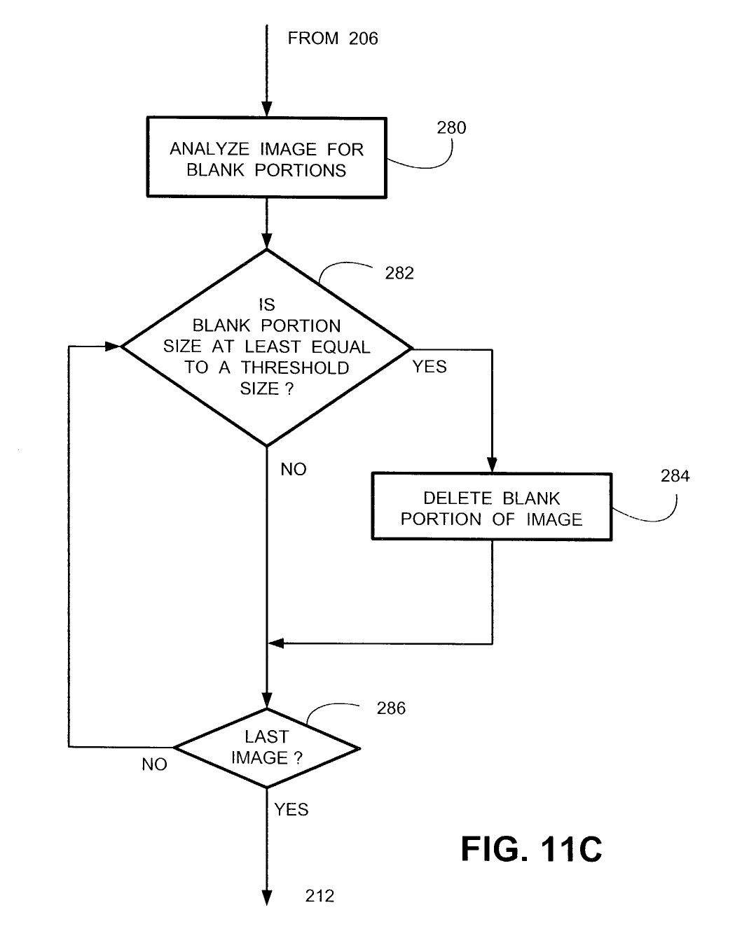

At block 208, characteristics of the received images are analyzed. In one embodiment, analyzed characteristics in block 208 include the presence of blank regions, presence of color and or identification of the sender of the received images. Other characteristics may be analyzed by alternative embodiments. Also, some characteristics may be selectable. Other embodiments may include fewer characteristics, more characteristics, or different characteristics. At block 210, appropriate conservation measures based upon the analyzed characteristics are applied to the document. For convenience, the process for analyzing the above-listed characteristics and applying conservation are discussed below and are further described in FIGS. 11A-C.

The process then proceeds to block 212, where the maximum amount of reduction is determined for each image. Accordingly, the area of some images may be reduced up to a quarter size, half size, or another determined size. Other images may not be suitable for reduction, and accordingly, would be printed at their received size.

At block 214, the layout for each print page is determined. Any number of layout preferences may be specified at block 214. Exemplary layout preferences were described for the printed pages of FIGS. 2-7. The layout preferences consider the total number of images, the maximum amount of reduction is determined for each image at block 214, the nature of the image (such as the presence of object blank regions, images and/or color), sender identification, and/or other preferences as described herein. Accordingly, the selection of layout preferences applied during image processing by the present invention, and the prioritization of the layout preferences with respect to each other, is a preference.

At block 216, the pages having reduced-sized images are communicated to a printing device. The process ends at block 218.

One aspect of the process of laying out images together onto a single sheet of paper for printing is the selection of the amount of reduction for each image. That is, the amount of image reduction is not necessarily equal to the maximum amount of reduction determined at block 212. The amount of reduction is determined by a variety of considerations. One consideration is the suitability of adjacent images for a related amount of reduction. That is, can adjacent images be reduced to the same amount, or reduced by a suitable multiple amount, so that the adjacent image are printable on the same sheet of paper?

Another consideration is the maximum amount of reduction applicable to adjacent images of a plurality of images. To save the most resources, it is generally understood that the greatest amount of reduction is desirable. However, in some instances, a lesser amount of reduction will conserve substantially the same resources as when the images are reduced to the maximum amount of reduction. Exemplary instances of this situation are described herein.

Characteristics of object images may also be considered. For example, but not limited to, the presence of color may be considered. (A color image may be desirable to print in full size with color when color of the image is important, and in another instance a reduced black-and-white printed image may be acceptable if color and/or image detail are not important.) In other instances, the object itself may be considered. (The image of a valuable object, such as art, may not be suitable for printing as a reduced black-and-white printed image.) Several illustrative examples herein illustrate these considerations.

With respect to the illustrative examples of FIGS. 2-4, it is understood that the maximum amount of reduction for images 102 and 104 is at least equal to a reduction to a quarter size area based upon the considerations of the images as described above. In the event that images 102 and 104 are part of a group of four images, each suitable for an area reduction to a quarter size or more, images 102 and 104 are reduced to a quarter size and printed, with two other images, on a single sheet of paper 132 (FIG. 2). Accordingly, a plurality of images having a common amount of reduction (quarter size) are considered in determining the layout of the images on the single sheet of paper 132.

However, in the example where images 102 and 104 are the only images in a received communication, reducing images 102 and 104 for printing on a single sheet of paper does not save paper compared to printing images 102 and 104 at half size on a single sheet of paper. Since the resolution of the images 102 and 104 at half size reduction is higher than at quarter size reduction, the present invention selects a half sized area reduction for images 102 and 104 for printing on a single sheet of paper 136 (FIG. 4). Accordingly, the present invention, considers the trade-off between printing images using the least amount of paper, and printing images with a higher resolution (least reduction).

Logic determining the layout of images may be configured to lay out images that have been reduced by different amounts. Consider a communication having three images 102, 104 and 106. With respect to FIGS. 3 and 5, the area of images 102 and 104 are reduced to a quarter size. However, the area of image 106 has been reduced to a quarter size in FIG. 3 and to a half size in FIG. 5. In both layouts, all three images 102, 104, and 106 are printed on a single sheet of paper 134 (FIG. 3) and 138 (FIG. 5). In the embodiment preparing the layout of images 102, 104, and 106 as illustrated in FIG. 5, logic determining the layout has been configured to recognize that it is desirable to layout images having object images with a higher resolution whenever possible. Compared to FIG. 3, reducing the area of image 106 to a quarter size results in a large portion of page 134 being blank. Accordingly, the above-described embodiments recognizes that image 106 can be printed at a higher resolution (half size) in image 106 is rotated by 90°. Thus, a characteristic of an image (images having object images) has been considered such that image 106 is printed with a higher resolution than images 102 and 104.

It is understood that depending upon the particular embodiment of the present invention, a variety of factors (such as image characteristics, resolution, number of images and the like) may be selected for consideration when images are reduced and laid out on a sheet of paper for printing. The above-described considerations are intended to illustrate principles of the present invention. It is further understood that because of the large number of considerations that may be selected for laying out images on a sheet of paper for printing, the order that such considerations are considered, and priorities among considerations, describing all possible combinations of such considerations is not practical herein. After reading the disclosure of the present invention, one skilled in the art will be able to practice the present invention by selecting those considerations of interest for the specific embodiment being practiced. Accordingly, it is intended that all such embodiments are disclosed herein.

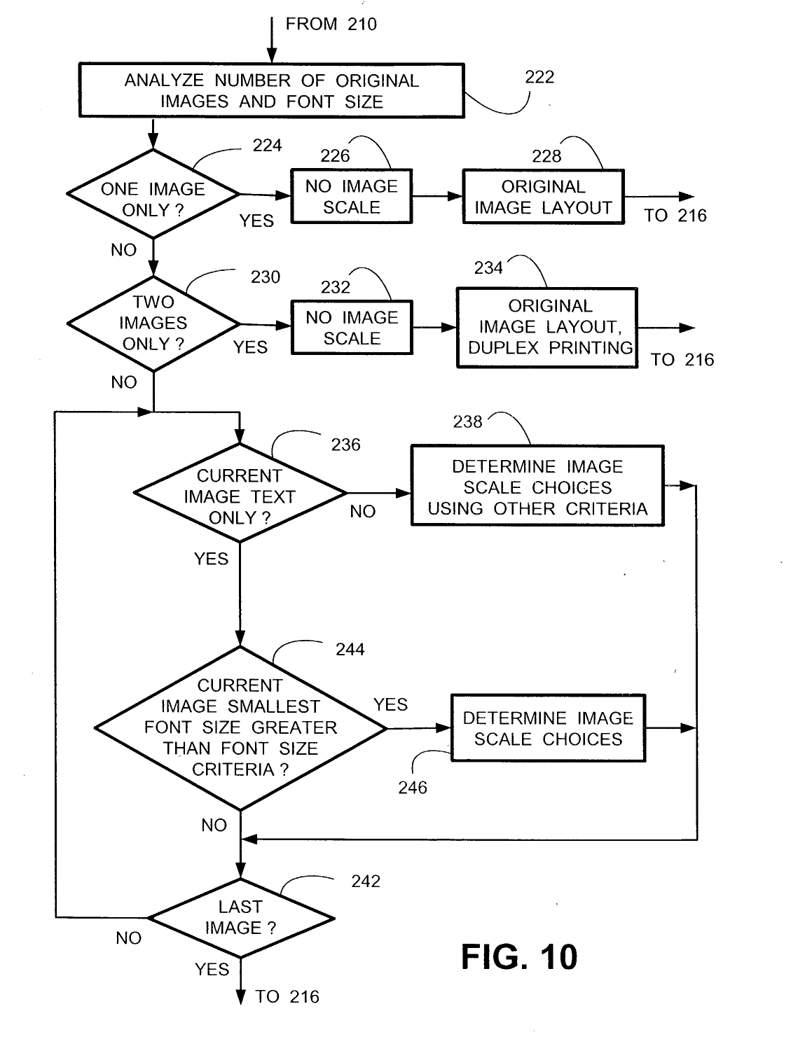

FIGS. 10 and 11A-C are a flowcharts illustrating additional detail of selected blocks of the flowchart of FIG. 9. The flow charts of FIGS. 10 and 11A-C show the architecture, functionality, and operation of a possible implementations of the software for implementing the resource conservation logic 166 (FIG. 8). In this regard, blocks of FIGS. 10 and 11A-C may represent modules, segments,-or portion of codes, which comprise one or more executable instructions for implementing the specified logical function(s). It should also be noted that in some alternative implementations, the functions noted in the blocks may occur out of the order noted in FIGS. 10 and 11A-C, or may include additional functions without departing significantly from the functionality of the present invention. For example, two blocks shown in succession in one of the FIGS. 10 and 11A-C may in fact be executed substantially concurrently, the blocks may sometimes be executed in the reverse order, or some of the blocks may not be executed in all instances, depending upon the functionality involved, as will be further clarified hereinbelow

Furthermore, the process in each one of the FIGS. 10, and 11A-C may sometimes be executed concurrently, serially, and/or portions of one process may be executed and then used as an input to another process illustrated in another one of the FIGS. 10 and 11A-C. All such modifications and variations are intended to be included herein within the scope of this disclosure for the present invention. The processes of FIGS. 10 and 11A-C are understood to be non-limiting exemplary processes that illustrate possible embodiments of the present invention. Accordingly, the construction of the resource conservation logic 166 that implements the process described in FIGS. 10 and 11A-C and/or the selection characteristics of an image is considered a preference.

FIG. 10 illustrates a process wherein the number of images and text font size are considered by the present invention during a process that conserves resources. The process begins with block 222 wherein the number of original images and font size is analyzed. The process proceeds to block 224 where a determination is made whether there is only one image. If so (the YES condition), the process proceeds to block 226 where the image is not scaled. The process proceeds to block 228 where the layout preference is determined to be the layout of the original received image. Since there is only one image, the process proceeds to block 216 where the image is communicated to a printer.

If at block 224 a determination is made that more than one image is to be processed by the present invention (the NO condition), the process proceeds to block 230. At block 230 a determination is made whether there are only two images. If so (the YES condition), the process proceeds to block 232 where the images are not scaled. The process proceeds to block 234 where the layout preference is determined. In the embodiment illustrated by FIG. 10, the images are laid out with duplex printing. That is, one image will be printed (without reduction) on one side of a sheet of paper and the second image is printed (without reduction) on the other side of the same sheet of paper when the images are printed. If the printing device is not capable of duplex printing, blocks 230, 232 and 234 are omitted.

If more than two images are to be processed by the present invention, as determined at block 230 (the NO condition), the process proceeds to block 236. At block 236 a determination is made whether the current image is a text only image. If not (the NO condition), the process proceeds to block 238 where scale choices using other criteria are made. For example, if the current image includes blank portions and/or images of objects, relevant criteria are applied by the present invention. The process then proceeds to block 242.

At block 242, if the current image is the last image (the YES condition), the process proceeds to block 216 where the images are communicated to a printer. If at block 242 the current image is not the last image (the NO condition), the process returns to block 236. That is, there are additional images to be analyzed.

If at block 236 the analyzed image has text only (the YES condition), the process proceeds to block 244. At block 244 the smallest font size of the current image is compared with the font size criteria. If the font size of the current image is greater that the font size criteria (the YES condition), the process proceeds to block 246 to determine scale choices. With reference to FIGS. 2-7, in one embodiment, the current image may be determined to be suitable for reduction to a half size area, for reduction to a quarter size area, or for reduction to another area. The process then proceeds to block 242.

FIG. 11A illustrates a process wherein the images are analyzed for color by the present invention during a process that conserves resources. The process illustrated in FIG. 11A begins with block 250 (corresponding to a portion of blocks 208 and 210 in FIG. 9) wherein images are analyzed for color. The process proceeds to block 252 where a determination is made whether the image includes color. If not (the NO condition), the process proceeds to block 254. At block 254, if the current image is the last image (the YES condition), the process proceeds to block 212. If at block 254 the current image is not the last image (the NO condition), the process returns to block 252. That is, there are additional images to be analyzed.

If at block 252 at least a portion of the current image has color (the YES condition), the process proceeds to block 256 where the color(s) of the image is determined. The process proceeds to block 258, where a determination is made whether the image is suitable for printing with black ink only. In not (the NO condition), the process proceeds to block 254. For example, the image may be a color photograph, a diagram or the like where color is important and should not be printed using black ink only.

If at block 258 the image is suitable for printing with black ink (the YES condition), the process proceeds to block 260. That is, can the colored portions of the image be printed in black ink? At block 260 suitable gray scales for the colored portions of the image are determined. One embodiment employs a look-up table that correlates color with gray scale data. Other embodiments use other known algorithms to correlate color with gray scales.

The process proceeds to block 262, where the colored portions of the image are replaced with gray scale information such that the colored portions can be printed with black ink. The process then proceeds to block 254 to determine if additional images are to be analyzed for color. If so (the YES condition) the process returns to block 252. If not (the NO condition), the process proceeds to block 212.

Alternative embodiments may, before proceeding to block 212, determine other conservation preferences for the image. Thus, in other embodiments, the process proceeds to other processes. For example, the sender of the images may be analyzed.

FIG. 11B illustrates a process wherein the images are analyzed for the sender of the images. The process illustrated in FIG. 11B begins with block 270 (which corresponds to a portion of blocks 208 and 210 in FIG. 9) wherein the sender of the images is analyzed. In other embodiments, the process of FIG. 11B begins after another suitable block illustrated in the flow charts described herein.

In one embodiment, if the images are received via a telephone system, as when the images are FAX images, the telephone number and/or caller identification (ID) information is analyzed. In another embodiment, if the images are received via the Internet, as when the images a e-mail images, the header information and or sender address information is analyzed. Depending upon the communication medium over which the images are communicated, any suitable information identifying the sender of the image is identified.

The process proceeds to block 272 where a determination is made whether the sender of the image is known for sending important images. If so (the YES condition), the process proceeds to block 274. At block 274, image processing by the present invention is terminated and the process proceeds to block 216 where the images are communicated to a printer. For example, the sender may be known to typically communicate images having important detail, such as in images of photographs, legal documents or the like. Accordingly, image reduction is known to not be desirable when images are received from the identified sender.

If at block 272 the sender of the image is not known for sending important images (the NO condition), the process proceeds to block 276 where a determination is made whether the sender of the image is known for sending undesirable images, such as junk mail or the like. If so (the YES condition), the process proceeds to block 278. At block 278, a default value is specified for image reduction. For example, the sender may be known to typically communicate junk mail, such as in images of advertisements or the like. Accordingly, image reduction by a predetermined amount is known to be desirable when images are received from the identified sender.

If at block 276 the sender of the image is not known for sending undesirable images (the NO condition), the process proceeds to block 212 (FIG. 9) where the font size is analyzed such that images scale choices are determined.

In one embodiment, blocks 272 and 276 are implemented by a look-up table wherein the identify of senders know to communicate important images and/or undesirable images are stored. In one embodiment, the look-up table may be modified by the user. In another embodiment, the sender is identified by header information that indicates the received images are important, and should therefore not be reduced.

In an alternative embodiment, blocks 272 and 274 are omitted. Thus, the process screens for known senders of undesirable images. In yet another alternative embodiment, blocks 276 and 276 are omitted. Thus, the process screens for known senders of desirable images.

FIG. 11C illustrates a process wherein the images are analyzed for blank portions. The process illustrated in FIG. 11C begins with block 280 (which corresponds to a portion of blocks 208 and 210 in FIG. 9) wherein an image is analyzed to determine if blank portions in the image are present. In other embodiments, the process of FIG. 11C begins after another suitable block illustrated in the flow charts described herein.

At block 282 a determination is made whether the blank portion of the image is at least equal to a predefined size. If so (the YES condition), the process proceeds to block 284 where the blank portion is deleted. This process then proceeds to block 286.

At block 286 a determination is made whether there are additional images to analyze. If not, the process proceeds to block 212. If so (the YES condition) the process returns to block 282. If not (the NO condition), the process proceeds to block 208.

Alternative embodiments may, before proceeding to block 212, determine other conservation preferences for the image. Thus, in other embodiments, the process proceeds to other processes rather than to block 212. For example, the font size may be analyzed such that image reduction choices are determined. Or, the sender of the images may be analyzed.

It should be emphasized that the above-described embodiments of the present invention are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A method for conserving resources when images are printed, the method comprising the steps of:
receiving a communication comprising at least a plurality of images, the images lacking information specifying image attributes;
analyzing each image for at least one characteristic corresponding to the image attributes;
determining a maximum amount of reduction in size for each one of the images based upon the analyzed characteristic;
determining a page layout for selected ones of the plurality of images at the determined reduced-size such that at least two reduced-size images are laid out together onto a single sheet of paper; and
communicating the determined page layout to a printing unit so that the sheet of paper is printed having the selected reduced-sized images.

2. The method of claim 1, wherein the step of receiving further comprises receiving a facsimile communication comprising a plurality of pages wherein each of the pages corresponds to one of the plurality of images.

3. The method of claim 1, wherein the step of determining the maximum amount of reduction in size further comprises the step of determining at least a second reduced-size that each one of the images may be reduced to, the second reduced-size being greater than the maximum reduced-size.

4. The method of claim 1, wherein the step of determining the page layout further comprises the steps of:
selecting a reduced-size for each one of the images; and
combining selected ones of the plurality of images at the selected reduced-size onto the single sheet of paper.

5. The method of claim 1, further comprising the step of determining if a conservation feature is selected such that the steps of receiving, determining, analyzing and communicating are performed only when the conservation feature is selected.

6. The method of claim 1, wherein the step of analyzing further comprises the step of analyzing a number of the images received.

7. The method of claim 1, wherein the step of analyzing further comprises the steps of:
analyzing a font size of each received image to identify a smallest font size on the image;
comparing the identified smallest font size with a predetermined font size;
determining a maximum amount of reduction corresponding to the difference between the smallest font size and the predetermined font size; and
reducing the size of at least one image such that when the reduced-size image is printed on a sheet of paper, the reduced-size image is discernable.

8. The method of claim 7, wherein the step of determining the maximum amount of reduction further comprises the step of determining a second amount of reduction that at least one of the images can be reduced to, the second reduced-size being greater than the maximum reduced-size.

9. The method of claim 1, wherein the step of analyzing further comprises the steps of:
analyzing each received image for a blank region;
determining if the blank region can be deleted; and
deleting the blank region.

10. The method of claim 9, wherein the step of analyzing each received image for the blank region further comprises the steps of:
determining an area of the blank region; and
comparing the determined size with a predefined area such that the step of, deleting the blank region is performed when the determined area is at least equal to the predefined area.

11. The method of claim 9, wherein the step of analyzing each received image for the blank region further comprises the step of determining a width of the blank region such that the step of deleting the blank region is performed when the determined width is at least equal to a width of at least one image.

12. The method of claim 1, wherein the step of analyzing further comprises the steps of:
analyzing each received image for at least one color;
determining if the color can be printed with black ink, and
determining a gray scale corresponding to the at least one color when the step of determining determines that the image color can be printed using black ink, and such that when the received images are printed, the received images are printed using only black ink.

13. The method of claim 1, wherein the step of analyzing further comprises the steps of:
identifying a sender of the received images;
determining if the sender is known to send at least one important image such that the at least one important image is printed at a full size; and
determining if the sender is known to send a plurality of unimportant images such that the unimportant images are printed at a predefined reduced-size together on the single sheet of paper.

14. A system which conserves resources when images are printed, comprising:
a memory configured to receive a communication comprised of at least a plurality of images, the images lacking information specifying image attributes; and
a processor unit configured to evaluate at least one characteristic corresponding to the image attributes of each of the images to determine an amount of reduction for each one of the images, and further configured to layout selected ones of the reduced-sized images together on a single sheet of paper for printing.

15. The system of claim 14, further comprising a printing unit configured to receive the selected ones of the plurality of images laid out on the single sheet of paper for printing, and further configured to print the selected plurality of reduced-sized images laid out together on the single sheet of paper.

16. The system of claim 14, further comprising a printing unit interface configured to receive data corresponding to the selected plurality of reduced-sized images laid out together on the single sheet of paper for printing, and further configured to communicate the data to a printing device.

17. A system for conserving resources when images are printed, comprising:
means for receiving a communication comprised of at least a plurality of images, the images lacking information specifying image attributes;
means for analyzing at least one characteristic of each image corresponding to the image attributes;
means for determining at least a maximum amount of reduction for each one of the images;
means for determining a page layout for selected ones of the plurality of images at the determined reduced-size, such that a plurality of reduced-size images are laid out together onto a single sheet of paper; and
means for communicating the determined page layout to a printing unit so that the sheet of paper is printed having the selected reduced-sized images.

18. The system of claim 17, further comprising:
means for analyzing a font size of each received image to identify a smallest font size on the image;
means for comparing the identified smallest font size with a predetermined font size;
means for determining the maximum amount of reduction corresponding to the difference between the smallest font size and the predetermined font size; and
means for reducing the size of the image such that when the reduced-size image is printed on a sheet of paper, the reduced-size image is discernable.

19. A computer-readable medium having a program for conserving resources when a plurality of images lacking information specifying image attributes are printed, the program comprising logic configured to perform the steps of:
analyzing at least one characteristic of each one of the plurality of images;
determining at least a maximum amount of reduction for each one of the images;
determining a page layout for selected ones of the plurality of images at the determined reduced-size, such that a plurality of reduced-size images are laid out together onto a single sheet of paper; and
communicating the determined page layout to a printing unit so that the single sheet of paper is printed having the selected reduced-sized images.

20. The computer-readable medium of claim 19, wherein the logic configured to perform the step of determining the maximum amount of reduction in size further comprises logic configured to perform the step of determining at least a second reduced-size that each one of the images may be reduced to, the second reduced-size being greater than the maximum reduced-size.

21. The computer-readable medium of claim 19, wherein the logic configured to perform the step of determining the page layout further comprises logic configured to perform the steps of:
selecting a reduced-size for each one of the images; and
combining selected ones of the plurality of images at the selected reduced-size onto the single sheet of paper.

22. The computer-readable medium of claim 19, further comprising logic configured to perform the step of determining if a conservation feature is selected such that the steps of receiving, determining, analyzing and communicating are performed only when the conservation feature is selected.

23. The computer-readable medium of claim 19, wherein the logic configured to perform the step of analyzing further comprises logic configured to perform the step of analyzing a number of the plurality of images.

24. The computer-readable medium of claim 19, wherein the logic configured to perform the step of analyzing further comprises logic configured to perform the steps of:
analyzing a font size of each one of the images to identify a smallest font size on each image;
comparing the identified smallest font size with a predetermined font size;
determining a maximum amount of reduction corresponding to the difference between the smallest font size and the predetermined font size; and
reducing the size of at least one image such that when the reduced-size image is printed on a sheet of paper, the reduced-size image is discernable.

25. The computer-readable medium of claim 24, wherein the logic configured to perform the step of determining the maximum amount of reduction further comprises logic configured to perform the step of determining a second amount of reduction that at least one of the images can be reduced to, the second reduced-size being greater than the maximum reduced-size.

26. The computer-readable medium of claim 19, wherein the logic configured to perform the step of analyzing further comprises logic configured to perform the steps of:
analyzing each one of the plurality of images for a blank region;
determining if the blank region can be deleted; and
deleting the blank region.

27. The computer-readable medium of claim 26, wherein the logic configured to perform the step of analyzing each one of the plurality of images for the blank region further comprises logic configured to perform the steps of:
determining an area of the blank region; and
comparing the determined size with a predefined area such that the step of deleting the blank region is performed when the determined area is at least equal to the predefined area.

28. The computer-readable -medium of claim 26, wherein the logic configured to perform the step of analyzing each received image for the blank region further comprises logic configured to perform the step of determining a width of the blank region such that the step of deleting the blank region is performed when the determined width is at least equal to a width of at least one image.

29. The computer-readable medium of claim 19, wherein the logic configured to perform the step of analyzing further comprises logic configured to perform the steps of:
analyzing each one of the plurality of images for at least one color;
determining if the color can be printed with black ink; and
determining a gray scale corresponding to the at least one color when the step of determining determines that the image color can be printed using black ink, and such that when the images are printed, the images are printed using only black ink.

30. The computer-readable medium of claim 19, wherein the logic configured to perform the step of analyzing further comprises logic configured to perform the steps of:
identifying a sender of the plurality of images;
determining if the sender is known to send at least one important image such that the at least one important image is printed at a full size; and
determining if the sender is known to send a plurality of unimportant images such that the unimportant images are printed at a predefined reduced-size together on the single sheet of paper.
